(19) United States
(12) Patent Application Publication
(10) Pub. No.: US 2005/0017901 A1
(43) Pub. Date: Jan. 27, 2005

(54) Personal locator and security system

(76) Inventor: Stanislaw Koptiev, Coral Springs, FL (US)

Correspondence Address: Mark D. Bowen;Stearns Weaver Miller, et al., Suite 1900, 200 East Broward Boulevard, Fort Lauderdale, FL, 33301, US

(21) Appl. No.: 10/624,748

(22) Filed: Jul. 22, 2003

(51) Int. Cl. G01S 1/08

(52) U.S. Cl. 342/386

(57) ABSTRACT

A personal tracking and security system that allows for the tracking of persons and personal articles is disclosed. The system includes a distributed network of receiving stations spaced over a geographic region of coverage, and at least one personal electronic communication device that periodically communicates with one or more receiving stations. The receiving stations may be located in stores, offices, street and highway intersections, or on other structures. The personal electronic communication device, which, in contrast to conventional transmitters/receivers, has lower power consumption, smaller overall dimensions and weight, reduced cost, and at the same time, retains all functions necessary for electronic communications. The personal electronic device may be fashioned as a watch, bracelet, or pendant and is worn or carried by the user and/or article to be monitored and tracked. The receiving stations receive signals from the personal electronic communication device(s) within communication proximity of a given receiving station thereby obtaining an approximate position fix on the device and hence the user. The system is further adapted for transmitting the location coordinates at regular intervals to designated tracker units or tracker locations, such as a cellular telephone, or local police headquarters.

### CROSS REFERENCE TO RELATED APPLICATIONS

N/A

### STATEMENT REGARDING FEDERALLY SPONSORED RESEARCH OR DEVELOPMENT

N/A

### COPYRIGHT NOTICE

A portion of the disclosure of this patent document contains material that is subject to copyright protection. The copyright owner has no objection to the facsimile reproduction by anyone of the patent document or patent disclosure as it appears in the Patent and Trademark Office patent file or records, but otherwise reserves all copyrights rights whatsoever.

### BACKGROUND OF THE INVENTION

1. Field of the Invention

The present invention relates to tracking and locator systems, and more particularly to a personal global positioning locator system.

2. Description of Related Art

A number of systems capable of tracking objects are known in the background art. Such systems, however, are limited in application as a result of bulky size and relatively high power consumption. However, the development of receivers of global positioning system (“GPS”) signals with such overall dimensions, weight and power consumption, that would allow construction of probable GPS receivers with personal means of mobile radio communication presents opportunities for the development of personal GPS tracking systems. Accordingly, minimizing the overall dimensions, power consumption, and complexity of a system of receivers used to acquire and communicate positioning signals is important.

U.S. Pat. No. 5,319,374, issued to Desai et al. discloses a system adapted for tracking vehicles supplied with a unit capable of obtaining a position-fix from GPS signals and equipment for radio communication with a central station, which carries out monitoring of the position of the vehicles.

U.S. Pat. No. 5,355,140, issued to Slavin et al., discloses a system for reporting of an emergency event experienced by a marine vessel, an airborne vessel or by an occupant of the vessel.using a position-determining Global Positioning System, such as the Navstar system or the GLONASS system. If an emergency occurs on the vessel, the approximate present position and time of occurrence of this event is broadcast on one or more of the mobile communication or emergency radiowave bands. Optionally, vessel velocity heading and/or vessel position quality of fix information is also broadcast by a vessel in distress.

While the background art discloses systems adapted for providing position-fixes for vehicles such as trucks and boats, there remains a need for a personal locator system particularly adapted with a locator device to be carried and/or worn by users.

### BRIEF SUMMARY OF THE INVENTION

The present invention overcomes the limitations present in the art by providing a personal tracking and security system that allows for the tracking of persons and personal articles. The system includes a distributed network of receiving stations spaced over a geographic region of coverage. In addition, the system includes at least one personal electronic communication device that periodically communicates with the receiving stations. The personal electronic communication device, which, in contrast to conventional transmitters/receivers, has lower power consumption, smaller overall dimensions and weight, reduced cost, and at the same time, retains all functions necessary for electronic communications. The personal electronic device may be fashioned as a watch, bracelet, or pendant and is worn or carried by the user and/or article to be monitored and tracked. The receiving stations receive signals from the personal electronic communication device(s) within communication proximity of a given receiving station thereby obtaining an approximate position fix on the device and hence the user. The receiving stations may be located in stores, offices, street and highway intersections, and on other structures. The system is further adapted for transmitting the location coordinates at regular intervals to designated tracker units or tracker locations, such as a cellular telephone, or local police headquarters.

Accordingly, it is an object of the present invention to provide an improved GPS tracking system.

Another object of the present invention is to provide a system for tracking user's carrying a personal electronic communications device.

In accordance with these and other objects, which will become apparent hereinafter, the instant invention will now be described with particular reference to the accompanying drawings.

### BRIEF DESCRIPTION OF THE SEVERAL VIEWS OF THE DRAWINGS

FIG. 1 depicts a perspective view of a personal electronic communication device according to the present invention;

FIG. 2 depicts a side view thereof;

FIG. 3 is a partial exploded top perspective view thereof;

FIGS. 4-6 are exploded views depicting the housing and electronic components thereof;

FIG. 7 is a top perspective view of the personal electronic communication device housing with the top removed;

FIG. 8 is a bottom view of the housing;

FIG. 9 depicts the housing adapted for use as a pendant;

FIG. 10 is a bottom view of the personal electronic communication device depicted in FIG. 1; and

FIG. 11 is a flow chart depicting communication paths according to the present invention.

### DETAILED DESCRIPTION OF THE INVENTION

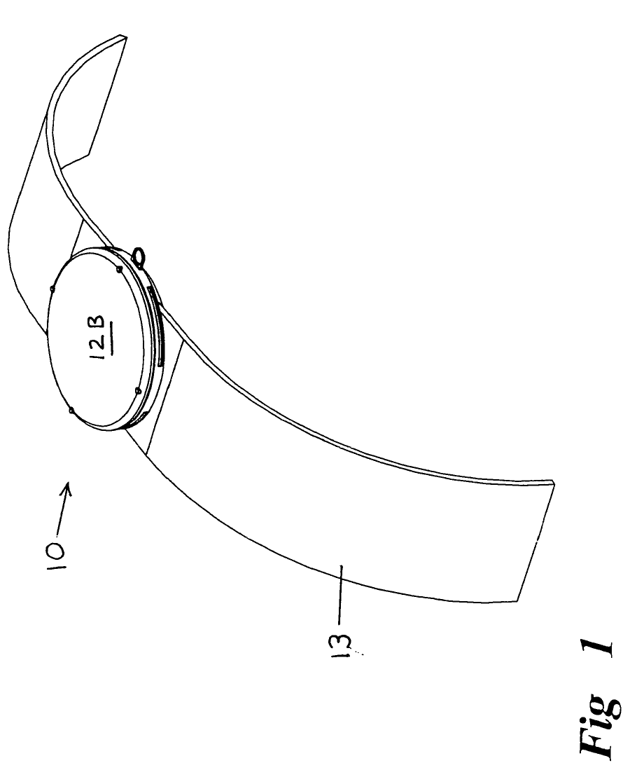

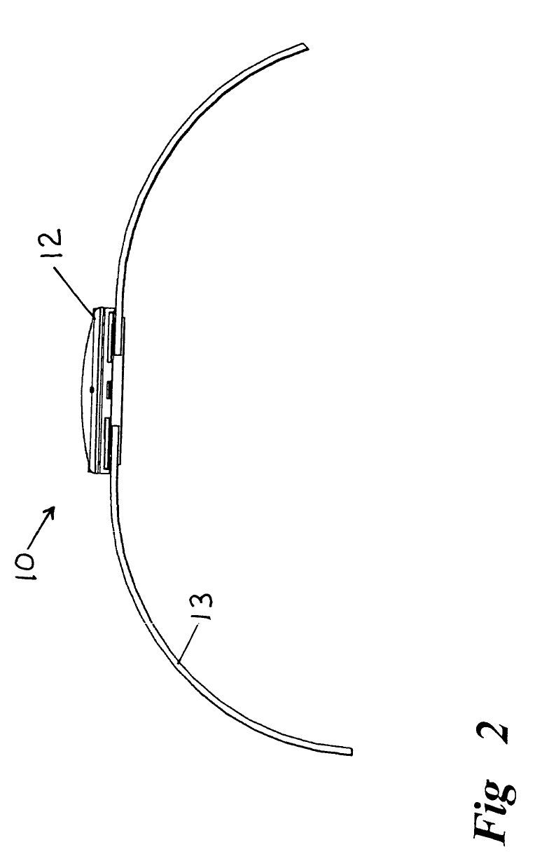

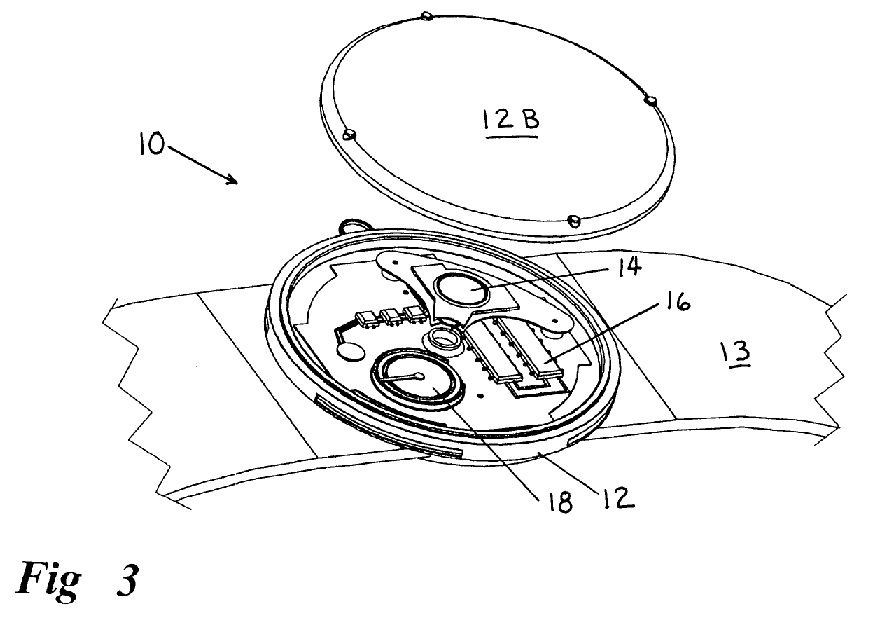

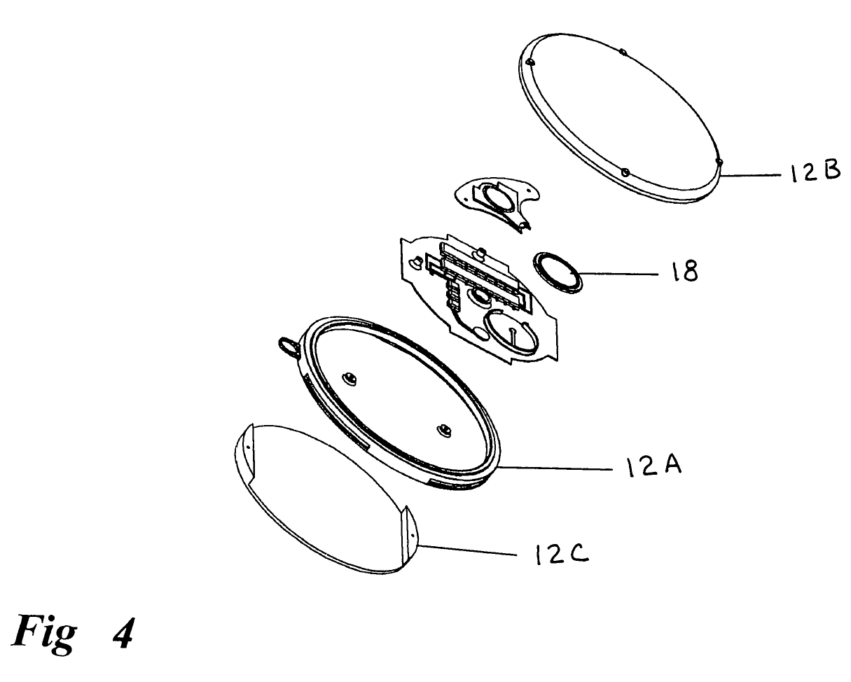

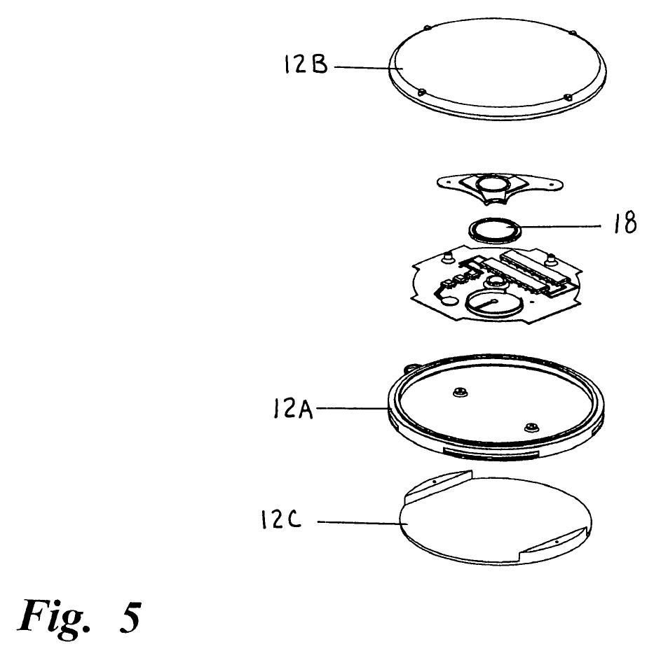

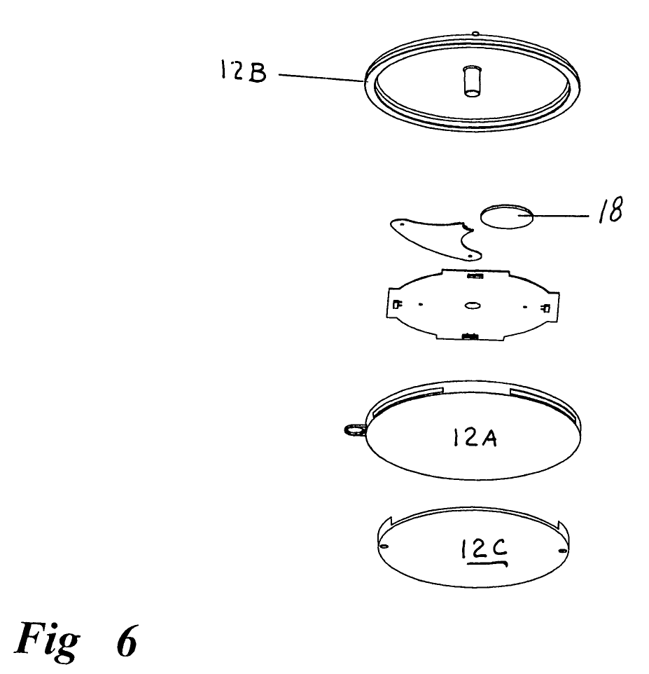

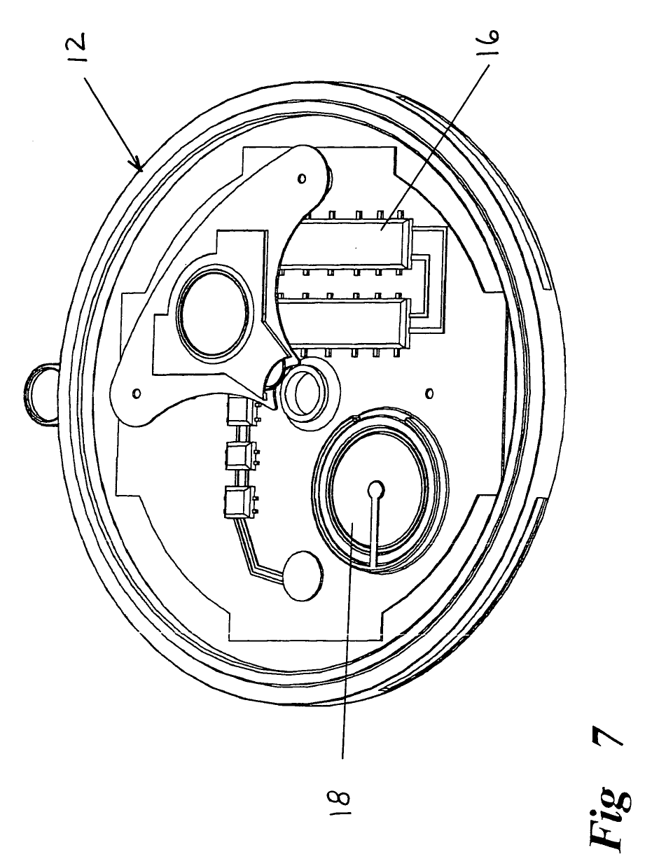

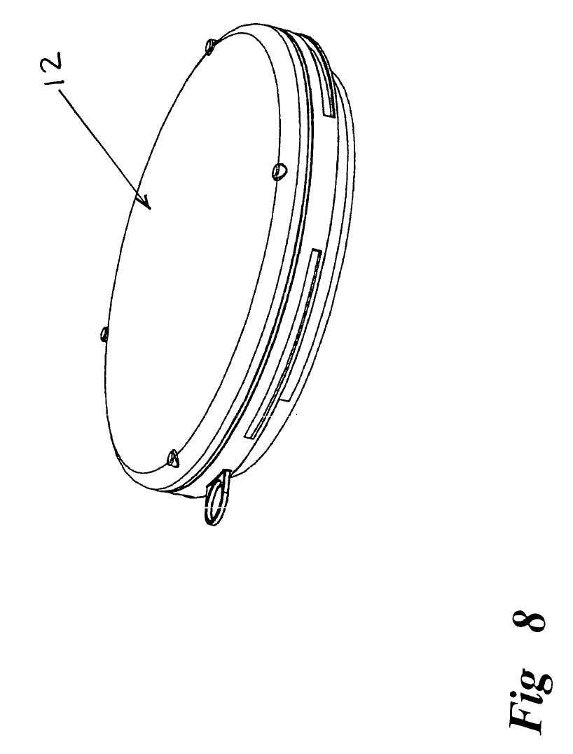

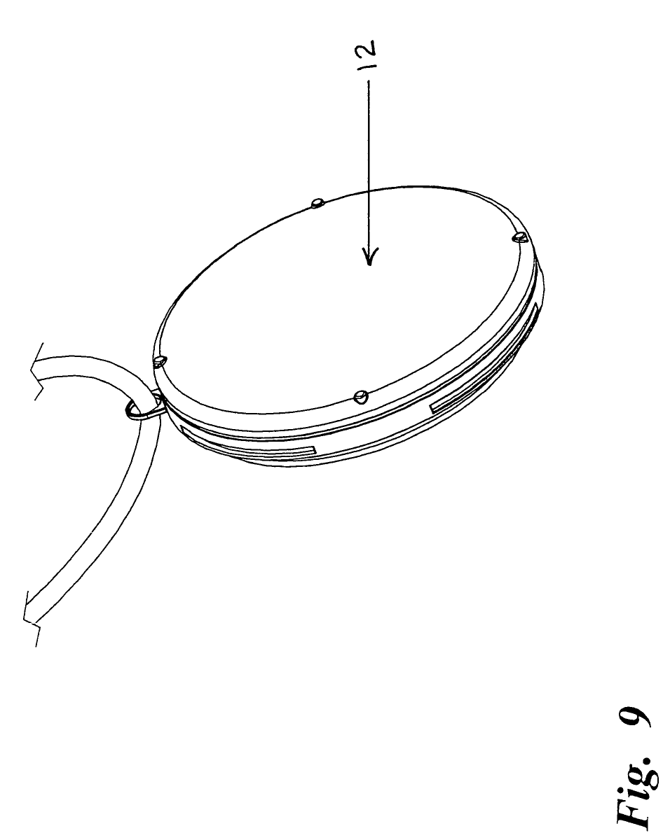

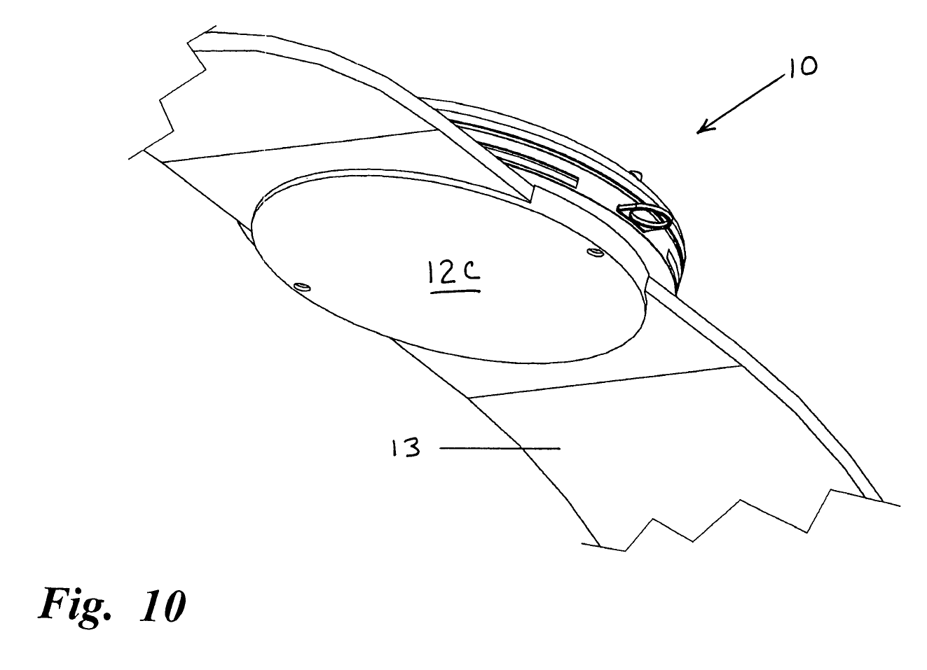

With reference to the drawings there is depicted a personal locator system according to the present invention. The present invention overcomes the limitations present in the art by providing a personal tracking and security system that allows for the tracking of persons and personal articles. The system includes at least one personal electronic communication device, generally referenced as 10, to be worn or carried by the user to be tracked/monitored. Device 10 may be configured as a watch, bracelet, or pendant and is worn or carried by the user and/or article to be monitored and tracked. FIGS. 1 and 2 depict a watch embodiment and FIG. 9 depicts a pendant embodiment. Device 10 includes a housing 12 for containing electronic components. Housing 12 preferably includes a base 12A, a cover 12B, and a base plate 12C for securing a wrist band 13. Housing 12 is preferably waterproof and houses electronic components preferably including transmitters/receiver circuitry 14, and a computer chip/processor 16, each of which are characterized as having low power consumption, smaller overall dimensions and weight, and reduced cost, while retaining all functions necessary for electronic communications. The electronic components further include a battery power source 18. The electronic components may comprise technology similar to that used in wireless and/or cellular communications. The electronic

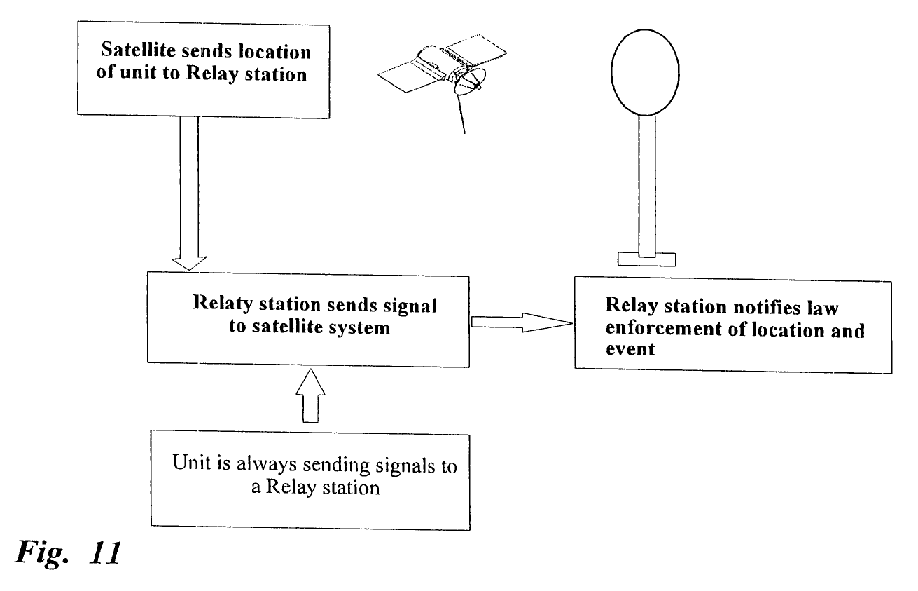

The present invention further includes a plurality of relay stations fixed at various geographic locations as depicted in FIG. 11. The relay stations receive signals from the personal electronic communication device(s) within communication proximity of a given relay station thereby obtaining an approximate position fix on the device and hence the user. Since the relay station is fixed at a given location, its location coordinates (i.e. GPS coordinates—latitude and longitude) are known. Relay stations may be located in stores, offices, street and highway intersections, or at any other suitable location. Each relay station is configured for transmitting the location coordinates of an electronic device 10 within proximity to the relay station at regular intervals to designated tracker units or tracker locations, such as a cellular telephone, or local police headquarters.

The present invention thus operates according to the following example. In a geographic area wherein 5 relay stations are located a user wearing an electronic device 10 enters the geographic area and the electronic device transmits a signal to at least one of said relay stations. The signal transmitted by the electronic device may include global positioning coordinates thereby precisely identifying the location of the device. In the event the electronic device does not transmit global positioning coordinates, the coordinates for the relay station may be used to identify, as precisely as possible, the location of the user with the electronic device. In either event, location coordinates are transmitted from the relay station via known cellular, radio, and/or satellite, to a predetermined tracking device. The predetermined tracking device may include a cellular telephone, personal telephone, pager, e-mail address, or any other suitable message receiving device or system.

The instant invention has been shown and described herein in what is considered to be the most practical and preferred embodiment. It is recognized, however, that departures may be made therefrom within the scope of the invention and that obvious modifications will occur to a person skilled in the art.

1. A personal location tracking system comprising:
a plurality of relay stations fixed in geographical regions, each of said relay stations configured to receive electronic signals and to transmit electronic signals via a transmitter;
at least one portable electronic communication device, said device including means for transmitting an electronic signal for reception by at least one of said plurality of relay stations, said transmitted electronic signal including information identifying the portable electronic communication device;
at least one portable tracking unit adapted to receive electronic signals from said plurality of relay stations, whereby position coordinates for each of said portable electronic devices is received by said at least one portable tracking unit.

2. A personal location tracking system according to claim 1, wherein said at least one portable electronic communication device is adapted for obtaining and transmitting latitude and longitude coordinates for said device.

3. A personal location tracking system comprising:
a plurality of relay stations fixed in geographical regions, each of said relay stations configured to receive electronic signals via a receiver and to transmit electronic signals via a transmitter, each of said relay stations including position indicating data;
at least one portable electronic communication device, said device including a battery power source and means for periodically transmitting an electronic signal for reception by at least one of said plurality of relay stations, said transmitted electronic signal including information identifying the portable electronic communication device and automatically updated position coordinates for said electronic device;
at least one portable tracking unit adapted to receive electronic signals transmitted from said plurality of relay stations, whereby position coordinates for each of said portable electronic devices is received by said at least one portable tracking unit.

4. A personal location tracking system according to claim 3, wherein said portable electronic communication device further includes a receiver configured to communicate with a global positioning system.
